(19) United States
(12) Patent Application Publication
(10) Pub. No.: US 2023/0160257 A1
(43) Pub. Date: May 25, 2023

(54) SLAT FOR ROLLER SHUTTERS, SHUTTER COMPRISING SUCH A SLAT AND PLANT FOR MANUFACTURING SUCH A SHUTTER

(71) Applicant: DALLAN S.P.A., Treviso (IT)

(72) Inventor: Andrea DALLAN, Treviso (IT)

(21) Appl. No.: 18/057,143

(22) Filed: Nov. 18, 2022

(30) Foreign Application Priority Data
Nov. 19, 2021 (IT) 102021000029336

(51) Int. Cl. E06B 9/165

(52) U.S. Cl. CPC E06B 9/165; E06B 2009/17092

(57) ABSTRACT

A slat for roller shutters includes an internally hollow elongated body extending along a longitudinal direction with a first face and opposite second face, designed to turn respectively towards the outside and inside of the compartment closed by the shutter. A cavity along a first longitudinal edge of the body is delimited by a first appendage on the first face, and a second appendage on the second face. A coupling appendage extends from a second longitudinal edge. Two recesses are at ends of the second longitudinal edge. Two notches on the second appendage near the opposite ends extend transverse to the first longitudinal edge, and define, on the second appendage, first and second tabs at opposite ends of the body. Each tab bends against the first appendage to close the coupling cavity at the ends of the body. The first appendage extends continuously from one end of the body.

### CROSS-REFERENCE TO RELATED APPLICATION

This application claims the benefit of Application No. 102021000029336, filed 19 Nov. 2021 in Italy, and which application is incorporated herein by reference. To the extent appropriate, a claim of priority is made to the above disclosed application.

### FIELD OF APPLICATION

The present invention relates to a slat for roller shutters, a shutter comprising such a slat and a plant for manufacturing such a shutter.

### PRIOR ART

A roller shutter for windows and glass doors consists of a plurality of slats which are identical to one another and coupled to one another along respective longitudinal edges. The slats are shaped so as to be able to be mutually coupled to one another. The coupling zones are configured to allow partial rotation between the slats about the longitudinal direction. As a result of this freedom of rotation between the slats, the roller shutter may roll up on itself. In this way, the shutter may be completely or partially raised or lowered by rolling one or more slats into a suitable container arranged above the window or glass door space, depending upon the opening requirements of the space itself.

Generally, as shown in FIG. 1, a traditional slat D consists of an elongated body E, in a metal or plastic material, which in use will face the outside of the compartment with a first face E1 (outer face) and towards the inside of the compartment with a second face E2 (inner face). The elongated body E comprises a coupling appendage A, extending along the whole of an upper longitudinal edge BS, and a hollow seat C extending along the whole of a lower longitudinal edge BI. The hollow seat C is delimited by a first portion C1 arranged on the outer face E1 of the elongated body E and by a second portion C2 of the elongated body, which is arranged on the inner face E2 of the elongated body E and is generally L-shaped. The two portions C1 and C2 are connected by a bottom wall C3.

The hollow seat C and the coupling appendage A are shaped so as to allow mutual coupling. In particular, the coupling appendage A engages with the L-shaped second portion C2. As shown in FIG. 2, in an assembled shutter, the coupling appendage of a first slat is inserted into the hollow seat of a second slat arranged above, while the hollow seat of this first slat receives therein the coupling appendage of a third slat (not shown) arranged below.

The hollow seat C of each slat is open at both longitudinal ends of the slat itself. In this way, one slat may be coupled to another by longitudinally sliding the coupling appendage of one slat inside the hollow seat of the other slat starting at one of the two ends.

To prevent the slats from slipping out of one another as a result of longitudinal sliding between appendages and hollow seats, it is known to provide the slats with end caps that, by coupling to the end profile of the slat, retain the coupling appendage inside the relevant hollow seat.

The adoption of end caps is however expensive insofar as it involves the supply of additional components (the caps) and requires a specific step for the application during the production process of the shutters.

As an alternative to the application of end caps, it is known to lock the coupling appendage inside the relevant hollow seat by deforming two opposite end portions of the hollow seat itself, so as to close the hollow seat at the two longitudinal ends and thus retain the coupling appendage therein which was previously shaped by removing two end portions having a width corresponding to the deformed portions of the hollow seat.

In more detail, as shown in FIG. 3, in the hollow seat C to be deformed is a flap of the first portion 01 arranged on the outer face E1 of the elongated body E. Before the coupling between the slats, the flap to be deformed is separated from the rest of the first portion 01 by means of a transverse notch that extends in depth up to the bottom wall C3. The same notch also partially affects the second portion C2, limited to the base of the L, in such a way as to implement a separate flap also in this second portion C2. Once the coupling appendage A has been inserted (suitably shaped), the aforementioned flap of the first portion 01 engages with the flap of the second portion C2, deforming it in turn. In particular, the base of the L is bent against the vertical portion of the L. In this way the hollow seat C1 is completely closed. This operation is carried out at both ends of the slat.

This technical solution 1, while allowing for the closure of the hollow seat C and therefore the locking of the coupling appendage inside the hollow seat C, has some drawbacks.

A first drawback is in relation to the fact that if the two coupled slats are rotated in relation to one another by an angle beyond 90°, it may happen that the coupling appendage A is forcibly inserted between the two deformed portions C1 and C2 and may slide out of the hollow seat C, at least partially, thereby compromising the complete functionality of the shutter.

A second drawback is related to the fact that the deformation of the flap of the first portion 01 modifies the outer face E1 of the elongated body E. This is at the expense of the aesthetic appearance of the slat itself on the most visible side and therefore the value of the same slat.

In the field of production of roller shutters there is therefore a need to have a slat that may be assembled to form a shutter while ensuring a more stable and secure coupling between the coupling appendage and the hollow seat, without at the same time requiring changes to the external face of the slat itself.

### DISCLOSURE OF THE INVENTION

Therefore, the main object of the present invention is to eliminate all or part of the drawbacks of the aforementioned prior art, in providing a roller shutter slat that may be assembled to form a shutter while ensuring a more stable and safe coupling between the coupling appendage and the hollow seat, without at the same time requiring modifications to the external face of the slat itself.

A further object of this invention is to provide a slat for roller shutters that is simple and cost-effective to produce.

### BRIEF DESCRIPTION OF THE DRAWINGS

The technical features of the invention, according to the aforementioned objectives, may be clearly seen in the content of the claims below, and the advantages thereof will become more readily apparent in the detailed description that follows, made with reference to the accompanying drawings, which represent one or more purely exemplifying and non-limiting embodiments thereof, wherein:

FIG. 1 is a cross-sectional view of a traditional slat for roller shutters;

FIGS. 2 and 3 show two slats of FIG. 1 coupled together and shown respectively before and after the deformation of the hollow seat;

FIG. 3a shows an enlarged detail of FIG. 3 relating to the coupling area between two slats with deformation of the coupling hollow seat;

FIG. 4 shows a perspective view of a slat for roller shutters according to a preferred embodiment of this invention, seen from the inner face;

FIG. 5 shows a perspective view of a slat for roller shutters according to a preferred embodiment of this invention, seen from the outer face;

FIG. 6 shows an orthogonal lateral view of the slat of FIG. 4;

FIGS. 7 and 8 show two orthogonal views of the slat of FIG. 4, respectively seen from the inner face and from the outer face;

FIG. 9 shows a lateral orthogonal view of a shutter according to a preferred embodiment of the invention, assembled with the slats shown in FIG. 4;

FIGS. 10 and 11 show two orthogonal views of the shutter of FIG. 9, respectively seen from the inner side thereof and from the outer side thereof;

FIGS. 12 and 13 show two perspective views of the shutter in FIG. 9, respectively seen from the inner and outer sides thereof;

FIGS. 14 to 17 show the main operational steps for the manufacture of a slat and a shutter according to the invention; and

FIG. 18 shows a lateral orthogonal view of a section of a shutter production plant according to the invention, comprised between a second cutting unit and a first crushing unit;

FIG. 19 shows a top-down orthogonal view of the section of the plant shown in FIG. 18; and

FIG. 20 shows a front orthogonal view of an assembly station of a shutter production plant according to the invention.

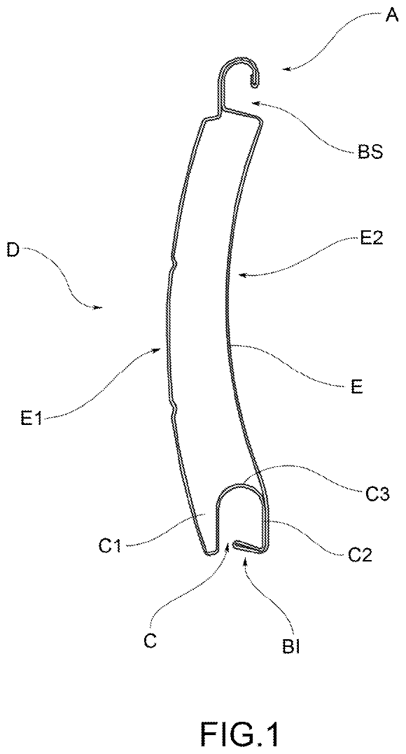

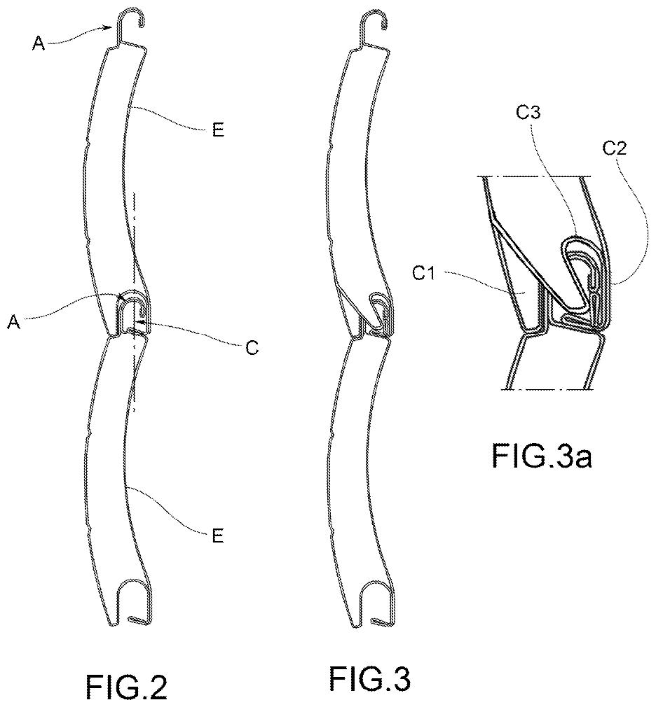

### DETAILED DESCRIPTION

The slat 1 for roller shutters according to the invention has been indicated as a whole by the reference number 1 in the accompanying figures.

Herein and in the following description and claims, reference will be made to the slat 1 in an assembled condition inside a shutter. Therefore, any references to a lower or upper position or to a horizontal or vertical orientation should be interpreted in this sense.

According to a general embodiment of the invention, the roller shutter slat 1 comprises an internally hollow elongated body 10, which extends along a longitudinal direction X and comprises a first face 10e and a second face 10i, opposite the first, which in use are designed to be turned respectively towards the outside and inside of the compartment closed by the shutter of which said slat 1 is designed to form a part.

The elongated body 10 comprises:
a coupling cavity 20, which is formed along a first longitudinal edge 11 of said elongated body 10
a coupling appendage 30 which extends from a second longitudinal edge 12 of said elongated body 10, opposite the first edge 11.

Preferably, the elongated body 10 consists of a box-shaped body made by bending and profiling a metal sheet. The coupling cavity 20 is obtained integrally within the box-shaped body by bending the metal sheet; the coupling appendage 30 may also be obtained integrally within the box-shaped body (as shown in the attached figures) or alternatively it may constitute a separate piece applied to the box-shaped body.

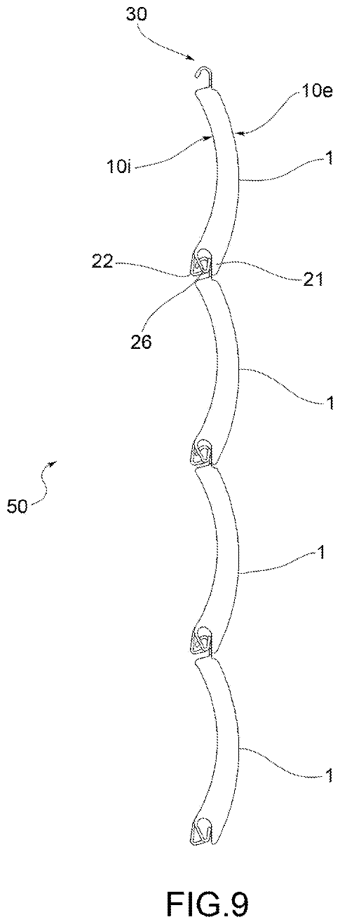

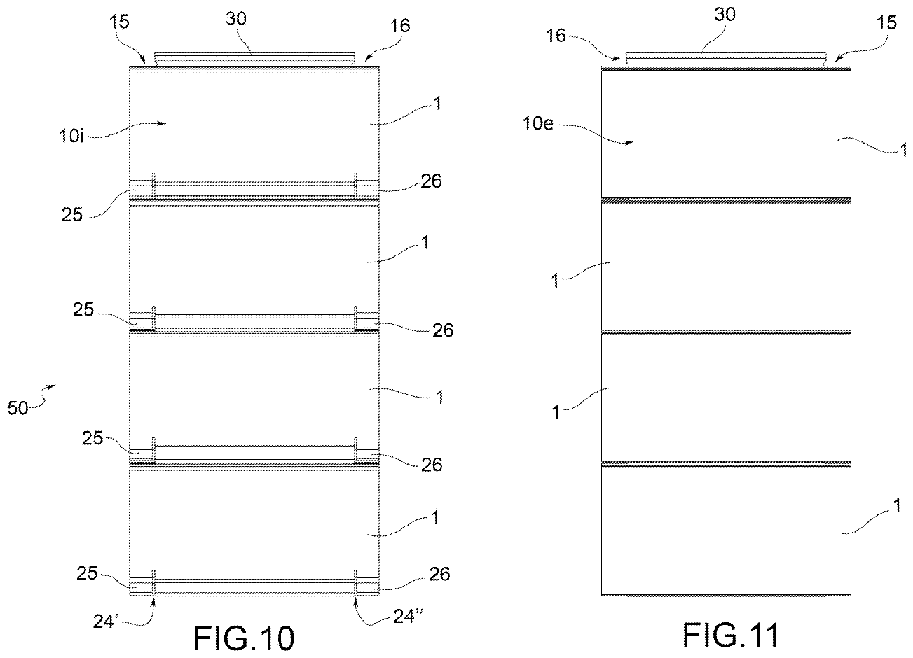

As shown in FIG. 9, the coupling cavity 20 is designed to be engaged by the coupling appendage 30 of a first slat, identical to said slat 1, while the coupling appendage 30 is designed to engage the coupling cavity 20 of a second slat that is identical to said slat 1.

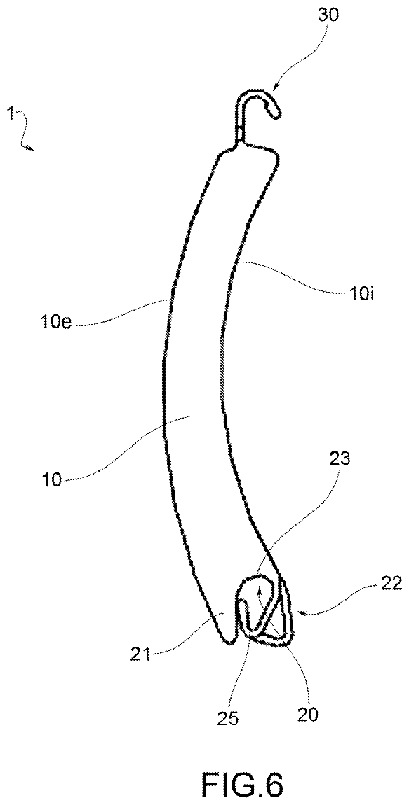

In more detail, as shown in particular in FIG. 6, the coupling cavity 20 is delimited by a first appendage 21 of the elongated body 10 obtained on the first face 10e and by a second appendage 22 of the elongated body 10 obtained on the second face 10i. These two appendages 21, 22 are connected to one another by means of a connecting portion 23 that defines the bottom of said coupling cavity 20.

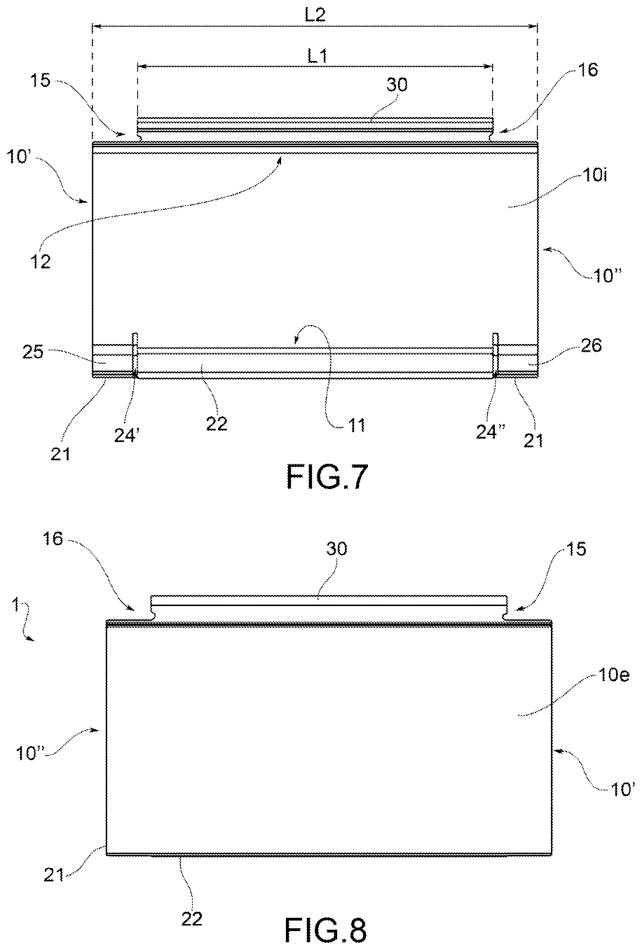

As shown in particular in FIGS. 7 and 8, the coupling appendage 30 has a longitudinal extension L1 that is smaller than the longitudinal extension L2 of the elongated body 10 so as to define two recesses 15, 16 at the ends of the second longitudinal edge 12 of the elongated body 10.

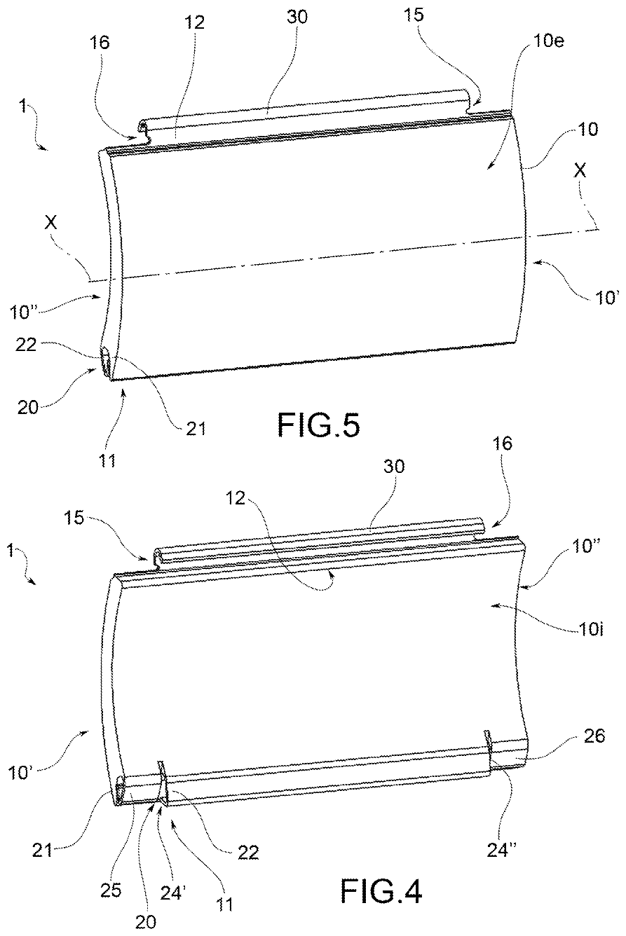

According to a first aspect of the invention, as shown in particular in FIGS. 4 and 7, the slat 1 comprises two notches (24′, 24″ which are obtained on said second appendage (22) near the two opposite longitudinal ends 10′ and 10″ of said elongated body 10 and extend transversely to said first longitudinal edge 11.

These two notches 24′, 24″ define, on said second appendage 22, a first tab 25 and a second tab 26 which are placed at the two opposite longitudinal ends 10′ and 10″ of said elongated body 10.

Each tab 25 and 26 is in a transversely opposite position (in relation to the longitudinal direction X) to one of said two recesses 15, 16 and has a longitudinal extension equal to or less than the respective recess.

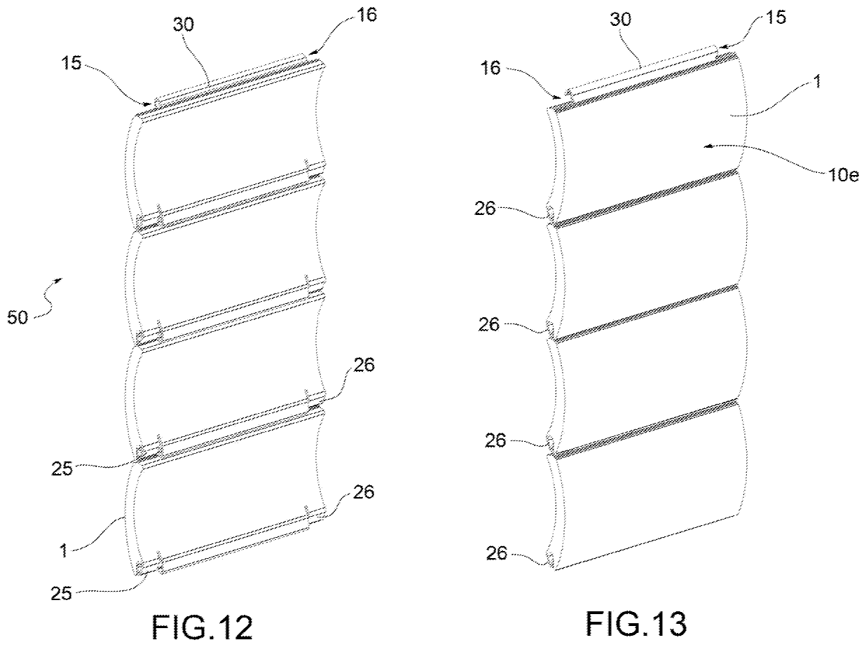

In use (as shown in the attached figures, and in particular in FIGS. 4, 6, 7, 9 and 12), each tab 25, 26 is designed to be bent against the first appendage 21 so as to close the coupling cavity 20 at the two opposite longitudinal ends 10′ and 10″ of the elongated body 10 once the coupling appendage 30 of an adjacent slat has been inserted into the coupling cavity (20) with the respective recesses 15 and 16 placed at the tabs 25 and 26.

According to a further aspect of the invention, the first appendage 21 develops continuously from one end of the elongated body 10 to the other, without interruption.

It was possible to verify in the field that closing the coupling cavity by bending only two end portions of the second appendage 22 (tabs 25 and 26) provides more stable and secure locking of the coupling appendage 30 of an adjacent slat within the coupling cavity 20.

Furthermore, such a technical closure solution leaves the first face 10e of the elongated body 10, i.e., the face of the slat 1 having a higher aesthetic value, unchanged. This significantly improves the aesthetic appearance of a shutter manufactured by assembling slats according to the invention.

The slat for roller shutters according to the present invention may therefore be assembled to form a shutter while ensuring a more stable and secure coupling between the coupling appendage and the hollow seat, without at the same time requiring changes to the external face of the slat itself.

Preferably, as shown particularly in FIG. 6, the aforementioned two notches 24′, 24″ extend transversely up to the connecting portion 23 which connects the two appendages 21 and 22 that define the coupling cavity 20. In this way, both tabs 25, 26 extend up to said connecting portion 23 and may be bent from the base starting from said connecting portion, maximizing the dimensions thereof within the coupling cavity when bent against the first appendage 21. This benefits the closure capacity of the coupling cavity on the part of the tabs.

Preferably, the second appendage 22 is L-shaped. In this way both of the tabs 25, 26 are L-shaped. The L-shaped configuration maximizes the dimensions of the tabs 25 and 26 within the coupling cavity when bent against the first appendage 21. This benefits the closure capacity of the coupling cavity on the part of the tabs.

Advantageously, as shown in the accompanying figures, the aforementioned two recesses 15, 16 have the same longitudinal extension. As will be clear from the following description, this simplifies the production process of the slat 1.

Advantageously, as shown in the accompanying figures, the two tabs 25, 26 have the same longitudinal extension. As will be clear from the following description, this simplifies the production process of the slat 1.

The subject of the present invention is also a roller shutter 50 comprising a plurality of slats coupled with one another in pairs. Each of said slats is a slat 1 according to the invention, and in particular as described above.

In the shutter 50, the two tabs 25, 26 of each slat 1 are bent against the first appendage 21 so as to close the coupling cavity 20 at the two opposite longitudinal ends 10′ and 10″ of the elongated body 10 and thus retain the coupling appendage 30 of the adjacent slat inside said coupling cavity 20.

As shown in particular in FIGS. 11 and 13, the shutter 50 manufactured by assembling slats 1 according to the invention does not show any machining marks on the external side associated with the assembly of the slats. This benefits the aesthetic appearance of the shutter.

Preferably, both tabs 25, 26 of each slat 1 extend to the connecting portion 23 connecting the first appendage 21 to the second appendage 22. Both tabs 25, 26 are bent in the vicinity of the connecting portion 23.

Preferably, both tabs 25, 26 are L-shaped and are bent at the portion defining the L-shaped vertical section.

The production process of the slat 1 according to the invention and the relative shutter 50 will now be described.

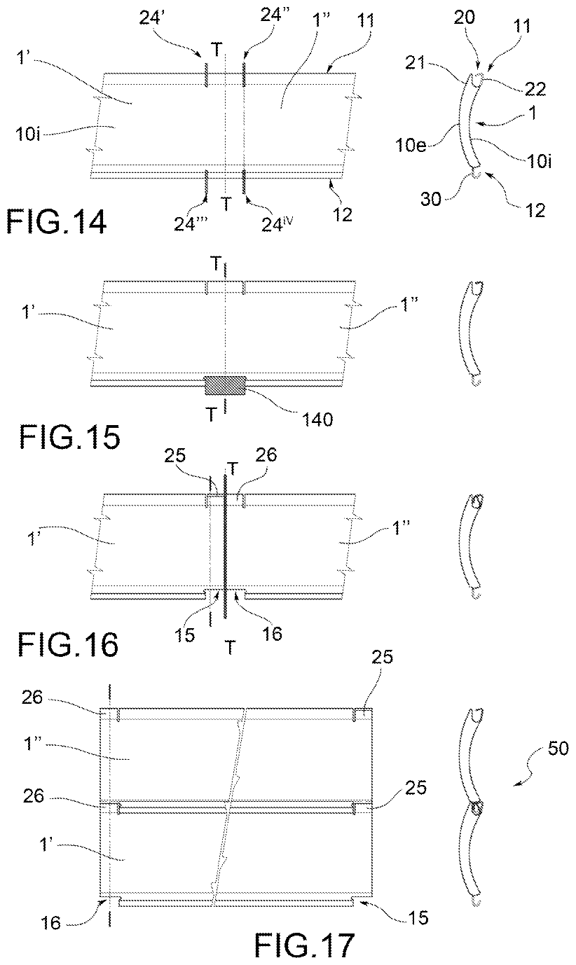

As shown in FIG. 14, the process starts from an elongated body preferably consisting of a box-shaped body obtained by bending and profiling a metal sheet. This elongated body corresponds to the elongated body 10 of the slat one according to the invention. By means of cutting operations transverse to the longitudinal direction X of the elongated body, sections corresponding to a slat 1 will be obtained.

Before cutting the elongated body, at the two longitudinal edges 11 and 12 of this elongated body, two pairs of notches 24′, 24″ and 24′″, 24iv are formed. A first pair of notches 24′, 24″ is made at the first longitudinal edge 11 and involves only the second appendage 22 implemented on the second face 10i (inner face) of the elongated body. A second pair of notches 24′″, 24iv is made at the second longitudinal edge 12 and involves only the coupling appendage 30 of the elongated body. The two pairs of notches are aligned transversely to one another in relation to the longitudinal direction X and straddle the cutting line T (or separation line) between two slats 1′ and 1″ obtainable by cutting the elongated body.

The portion of the second appendage 22 arranged between the first pair of notches 24′ and 24″ defines two tabs 25 and 26 of two contiguous slats 1′ and 1″ along the longitudinal development of said elongated body. These two tabs 25 and 26 will be separated from one another when the elongated body is cut in order to separate the two slats 1′ and 1″ from one another.

Subsequently, as shown in FIG. 15, the portion of the coupling appendage 30 arranged between the second pair of notches 24′″, 24iv is removed by cutting in order to create one of said two recesses 15, 16 on two contiguous slats 1′ and 1″ along the longitudinal development of said elongated body. These two recesses 15 and 16 will be separated therebetween when the elongated body is cut in order to separate the two slats 1′ and 1″ from one another.

Subsequently, as shown in FIG. 16, the two contiguous slats 1′ and 1″ are separated by cutting the elongated body along the cutting line T. After cutting, the tab 25 of one of the two slats 1′ is bent against the relative first appendage 21. In this way, the coupling cavity 20 of this slat 1′ will then be closed at one longitudinal end before the coupling appendage of another slat is inserted into the aforementioned coupling cavity. Said bent tab 25 will act as an abutment element for the insertion of the coupling appendage 30 of said second slat.

The last slat obtained in succession by cutting the elongated body is ready to be coupled to the slat that was previously obtained by cutting the elongated body, as shown in FIG. 17. Once the coupling appendage of the penultimate slat has been inserted into the coupling cavity of the last slat produced, the tab 26 of the last slat produced is also bent by pressing, thus completing the locking of the coupling appendage just inserted.

The operations described above are repeated in sequence until a shutter 50 of a predefined length is completed.

The subject of the present invention is also a plant 100 for the production of a shutter 50 according to the invention, by assembling slats 1 according to the invention itself.

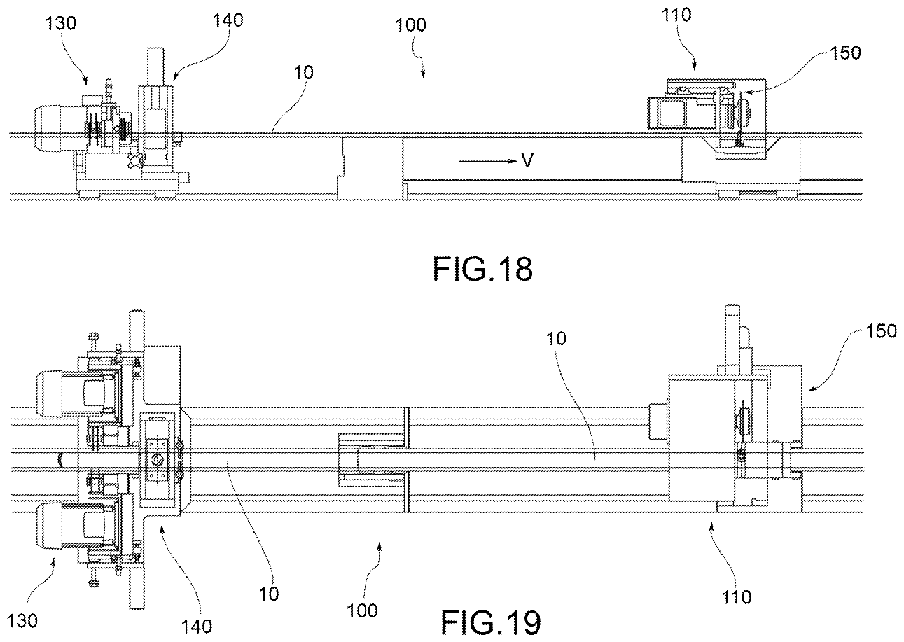

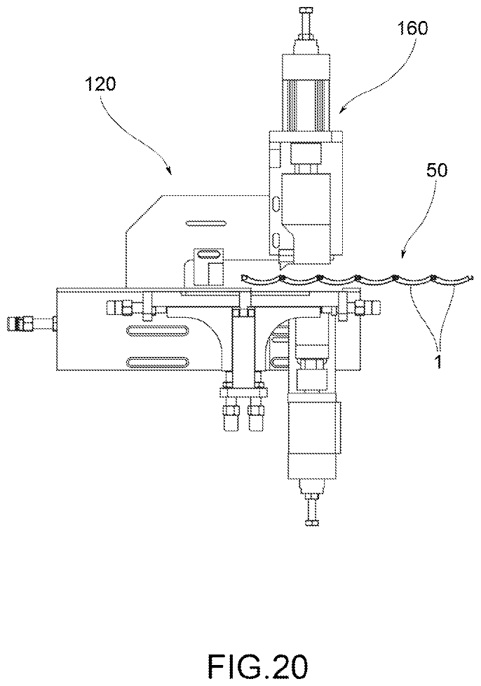

As shown in FIGS. 18, 19 and 20, said plant 100 comprises, in sequence in the direction of advancement V indicated in FIG. 18, the following:
a feeding unit for a continuous profile (not shown in the attached figures);
a bending and profiling station for said continuous profile (not shown in the attached figures) for obtaining an elongated body corresponding to the elongated body 10 of the slat 1 according to the present invention;
a first cutting unit 110 movable at the advancement speed of the continuous profile, programmed to cut the elongated body 10 into slats 1 of a predefined length;
an assembly station 120 of said slats 1 for forming a sheet of said shutter 50.

The assembly station 120 is arranged downstream of said first cutting unit 110.

According to the invention, the plant 100 further comprises a second cutting unit 130 movable at the advancement speed of the continuous profile, which unit operates between said bending and profiling station and said first cutting unit 110 and is programmed to implement the following:
a first pair of transverse notches 24′, 24″ on the first longitudinal edge 11 of the elongated body 10 at said second appendage 22 and
a second pair of transverse notches 24′″, 24iv on the second longitudinal edge 12 of the elongated body 10 at said coupling appendage 30.

These two pairs of notches straddle the cutting line T between two slats.

According to the invention, the plant 100 further comprises a shearing unit 140 movable at the advancement speed of the continuous profile, which unit operates between said second cutting unit 130 and said first cutting unit 110 and is programmed to remove the portion of the continuous profile arranged between the second pair of notches 24′″, 24iv in order to make one of said two recesses 15, 16 on two contiguous slats along the longitudinal development of said elongated body.

According to the invention, the plant 100 further comprises:
a first crushing unit 150, which operates between said first cutting unit 110 and said assembly station 120 and is programmed to bend, against the first appendage 21 of said elongated body 10, the profile portion that is comprised between one notch of said first pair of notches 24′, 24″ and the cutting line T between two slats and which defines a first tab 25, 26 of said slat 1 so as to close the coupling cavity 20 at a first longitudinal end of said slat 1; and
a second crushing unit 160, which is integrated into said assembly station 120 and is programmed to bend, against the first appendage 21 of said slat (1), the profile portion that is comprised between one notch of said first pair of notches 24′, 24″ and the cutting line T between two slats and which defines a second tab 25, 26 of said slat 1 so as to close the coupling cavity 20, also ata second longitudinal end of said slat 1 after the insertion of the coupling appendage 30 of another slat 1 into the coupling cavity 20.

The invention allows numerous advantages to be obtained, which have already been described in part.

The slat 1 for roller shutters according to the present invention may be assembled to form a shutter while ensuring a more stable and secure coupling between the coupling appendage and the hollow seat without at the same time requiring changes to the external face of the slat itself. This benefits the aesthetic aspect of the shutter obtainable by means of the assembly of slats according to the invention.

The slat 1 for roller shutters according to the invention is furthermore simple and cost-effective to produce.

The invention thus conceived therefore achieves its intended objectives.

Obviously, in practice it may also assume different forms and configurations from the one illustrated above, without thereby departing from the present scope of protection.

Furthermore, all details may be replaced with technically equivalent elements, and the dimensions, shapes, and materials used may be any according to the needs.

1. A slat for roller shutters, comprising an internally hollow elongated body which extends along a longitudinal direction and comprises a first face and a second face opposite the first face, which in use are configured to be turned respectively outwards and inwards of the compartment closed by the shutter comprising said slat; said elongated body comprising:
a coupling cavity obtained along a first longitudinal edge of said elongated body and is delimited by a first appendage of the elongated body obtained on the first face, and by a second appendage of the elongated body obtained on the second face, said first and second appendages being connected to each other by a connecting portion defining a bottom of said coupling cavity; and
a coupling appendage, extending from a second longitudinal edge of said elongated body, opposite the first edge;
wherein said coupling cavity is configured for engagement by the coupling appendage of a first slat identical to said slat, while said coupling appendage is configured to engage the coupling cavity of a second slat identical to said slat,
wherein said coupling appendage has a smaller longitudinal extension than a longitudinal extension of said elongated body to define two recesses at ends of the second longitudinal edge of said elongated body,
wherein two notches are obtained on said second appendage near two opposite longitudinal ends of said elongated body and extend transversely to said first longitudinal edge, said two notches defining on said second appendage a first tab and a second tab which are respectively placed at the two opposite longitudinal ends of said elongated body, each tab being in a position transversely opposite to one of said two recesses and having a longitudinal extension equal to or less than the respective recess, wherein in use each tab is configured to be bent against said first appendage to close the coupling cavity at the two opposite longitudinal ends of the elongated body, once the coupling appendage of an adjacent slat has been inserted into the coupling cavity with the respective recesses at the tabs; and
wherein said first appendage extends continuously from one end to the other end of the elongated body.

2. The slat according to claim 1, wherein said two notches extend transversely up to said connecting portion so that both of said tabs extend up to said connecting portion.

3. The slat according to claim 1, wherein said second appendage is L-shaped and wherein both of said tabs are L-shaped.

4. The slat according to claim 1, wherein said two recesses have a same longitudinal extension.

5. The slat according to claim 1, wherein said two tabs have a same longitudinal extension.

6. The slat according to claim 1, wherein said elongated body comprises a box-shaped body comprising a bent and profiled metal sheet.

7. A roller shutter, comprising a plurality of slats according to claim 1, the slats being coupled together in pairs, wherein the two tabs of each slat are bent against the first appendage to close the coupling cavity at the two opposite longitudinal ends of the elongated body and thus retain the coupling appendage of the adjacent slat inside said coupling cavity.

8. The roller shutter according to claim 7, wherein both of said tabs extend up to the connecting portion connecting the first appendage to the second appendage and wherein both of said tabs are bent near the connecting portion.

9. The roller shutter according to claim 7, wherein both of said tabs are L-shaped and are bent at a portion defining the vertical section of the L shape.

10. A plant for producing a shutter according to claim 7, comprising:
a feeding unit of a continuous profile;
a bending and profiling station of said continuous profile to obtain an elongated body corresponding to the elongated body of the slat according to claim 1;
a first cutting unit movable at an advancement speed of the continuous profile, programmed to cut said elongated body into slats of predefined length;
an assembly station of said slats to form a sheet of said shutter, arranged downstream of said first cutting unit,
a second cutting unit movable at the advancement speed of the continuous profile, which is operating between said bending and profiling station and said first cutting unit and is programmed to make a first pair of transverse notches on the first longitudinal edge of the elongated body at said second appendage and a second pair of transverse notches on the second longitudinal edge of the elongated body at said coupling appendage, said two pairs of notches being made astride a cutting line between two of the slats; and
a shearing unit movable at the advancement speed of the continuous profile, which is operating between said second cutting unit and said first cutting unit and is programmed to remove a portion of the continuous profile arranged between the second pair of notches to make one of said two recesses on two contiguous slats along the longitudinal extension of said elongated body;
a first crushing unit, which is operating between said first cutting unit and said assembly station and is programmed to bend against the first appendage of said elongated body the profile portion which is comprised between a notch of said first pair of notches and the cutting line between two slats and which defines a first tab of said slat to close the coupling cavity at a first longitudinal end of said slat; and
a second crushing unit, which is integrated in said assembly station and is programmed to bend against the first appendage of said slat the profile portion comprised between a notch of said first pair of notches and the cutting line between two slats and which defines a second tab of said slat to close the coupling cavity at a second longitudinal end of said slat after insertion of the coupling appendage of another slat into the coupling cavity.
